(19) United States
(12) Patent Application Publication
(10) Pub. No.: US 2002/0059169 A1
(43) Pub. Date: May 16, 2002

(54) System for quickly collecting operational data for internet destinations

(76) Inventors: John S. Quarterman, Austin, TX (US); Paul Murphy, Edinburgh (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/834,662

(22) Filed: Apr. 13, 2001

Related U.S. Application Data
(60) Provisional application No. 60/198,608, filed on Apr. 19, 2000.

(51) Int. Cl. G06F 7/00

(52) U.S. Cl. 707/1

(57) ABSTRACT

A system and method for collecting operational data is defined. An input list is provided. While there are more destinations left in the input list, the next specification is read, that ping is performed while its performance is timed (described in more detail below), and, the measurements are written to a data log. The logic of the measurement for a given destination and a set of global defaults is performed by the steps of: parsing the specification into its constituent parts; setting up the transaction request message; creating a TCP/IP socket and setting up input/output access to it; sending a “ping” to the destination; noting the timestamp for that ping transmission; waiting for a reply from the ping; noting the timestamp for that reply when it arrives; and calculating the time taken from transmit to reply. The socket and server connection can then be closed.

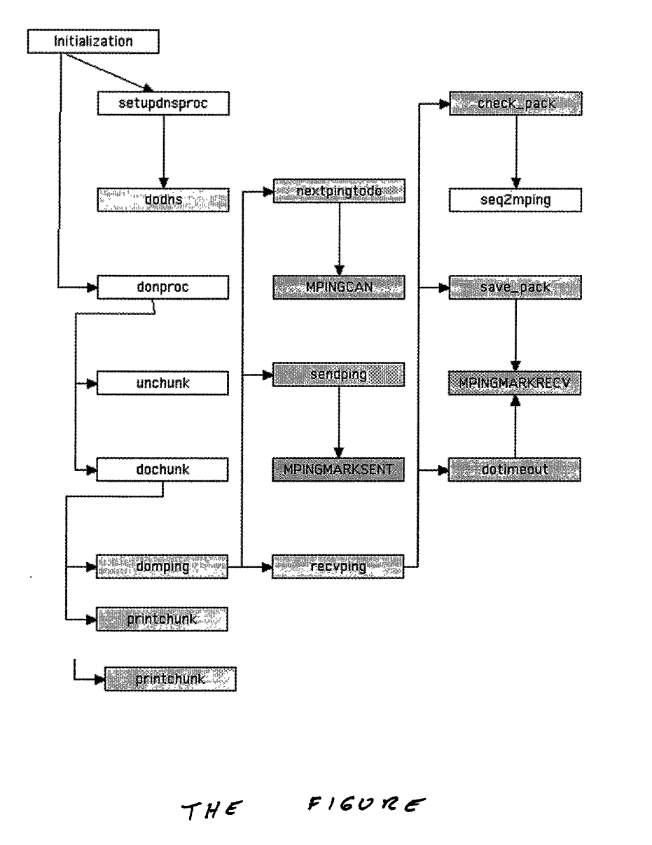

### CROSS-REFERENCE TO RELATED APPLICATIONS

This application claims the priority of U.S. application Ser. No. 60/198,608, which was filed Apr. 19, 2000.

### FIELD OF THE INVENTION

The present invention relates to the field of computer networks. More specifically, the invention relates to a method and system for collecting operational data for internet destinations.

### BACKGROUND OF THE INVENTION

The basic problem of needing to speed up collection of massive amounts of latency data has been known since 1996. The problem became acute in 1997, when a need to improve the Internet Weather Report arose.

Various problems with conventional systems have since been identified. Performing latency probes (pings) in sequence takes too long and most of the time is wasted waiting for responses from the remote servers. Further, performance timings could be negatively affected by the act of reading ping specs from, or writing measurements to, disk storage. In addition, the network interface and possibly the measurement processor could become overloaded if there were too many pings performed in parallel. This would make the performance measured seem worse that it actually was for some sites. The computer operating system could limit the number of communication “sockets” that may be open simultaneously (to a number much less than the desired number of simultaneous pings). In addition, batches of pings could fail to complete in a timely fashion when remote servers failed to reply. It takes a very long time to detect a remote server failure and hence that ping took a long time to complete (even in failure). Since all pings in a batch (chunk) need to complete before the batch itself can complete, processing of the entire list was held up. Because the pings to a destination are not always reliable, some remote servers seemed to be out of service when they were not. Also, there was variation in the time taken for the ping to complete. The first ping to a destination could produce different response characteristics than immediately succeeding pings, because the first ping could cause intervening Internet routers to allocate buffers that were thus already available when the succeeding pings pass through the same routers. Further still, because messages could be received from the remote servers other than the expected reply to the ping, the program could get confused. Complicating matters further, merely running multiple pings simultaneously in a chunk did not produce adequate speed of data collection. Finally, because looking up the name of a destination took a long time, processing can't proceed as fast as possible.

### SUMMARY OF THE INVENTION

The mping program is a massively parallelized program designed to use collect latency, packet loss, and reachability data from massive numbers of Internet destinations (computers) in a short time.

To collect this data, mping sends several probes to each destination. For each response packet, mping records the time difference (latency) between the original packet was sent and when its corresponding response was received. Mping also notes which probes do not receive responses within a timeout limit. To collect the data quickly, mping sends probes to many destinations simultaneously.

This program is implemented in C and therefore may run on multiple computer operating systems. This property of the program has been demonstrated by its first implementation running under Solaris on SPARCs and a second implementation running under Linux on Intel boxes.

An embodiment of the present invention solves the problem of performing latency probes (pings) in sequence taking too long and substantial time being wasted waiting for responses from the remote servers by sending many pings simultaneously.

An embodiment of the present invention solves the problem of performance timings being negatively affected by the act of reading ping specs from, or writing measurements to, disk storage by reading in a batch (also known as a chunk) of specifications up front, performing and measuring those pings in parallel (holding on to the data in fast memory), and when the batch is completed, writing out all of the measurements for the batch to the data log on (slow) disk. Batches are repeatedly processed until the complete list is processed. The size of the batch is limited by the amount of fast memory available. However, the size of the batch is more usually set to permit enough simultaneous flying pings without overloading the local CPU.

An embodiment of the invention solves the problem of the network interface and possibly the measurement processor becoming overloaded if there are too many pings performed in parallel by controlling (i.e. limiting) the number of pings performed in parallel independently of the batch size. The number of threads is limited by the capacity of the network interface and the amount of processing power available.

An embodiment of the invention solves the problem of the computer operating system limiting the number of communication “sockets” that may be open simultaneously (to a number much less than the desired number of simultaneous pings) by multiplexing all network transmissions through a single “socket” and de-multiplexing the replies received by matching each response to an identifier for the original ping.

An embodiment of the invention solves the problem of pings failing to complete in a timely fashion when remote servers fail to reply by establishing a time limit for each ping to complete. If the ping is not complete in time, it is abandoned and that ping is considered a failure on the remote server's part rather than waiting for the computer system to detect that a failure has occurred. This allows processing to continue and a cap on server response time to be established in the statistical categories.

An embodiment of the invention solves the problem of some remote servers appearing to be out of service when they are not and the variation in the time taken for the ping to complete by performing more than one ping per destination and averaging the results to get a more representative picture of performance and reachability.

An embodiment of the invention solves the problem of the first ping to a destination producing different response characteristics than immediately succeeding pings by not including the first ping in computations of performance characteristics to that destination.

An embodiment of the invention solves the problem of the program potentially getting confused due to messages other than the expected reply to the ping being received from the remote servers by filtering out all unwanted messages at the point of message receipt and only passing the expected messages on to the rest of the program.

An embodiment of the invention solves the problem of running multiple pings simultaneously in a chunk not producing adequate speed of data collection. This is possible because the invention relates not only to chunking, but also a process whereby each chunk of destinations that is read in provides a larger set of potential pings than are permitted to be flying at a given time. Thus when a ping is finished (response received or maximum time exceeded), another ping can start immediately, thus keeping the number of pings flying high.

An embodiment of the invention solves the problem of looking up the name of a destination taking a long time and slowing down processing by precomputing the name lookups (i.e. DNS lookup) so that the actual mping data collection can work from IP addresses.

### BRIEF DESCRIPTION OF THE DRAWING

The FIGURE is a flowchart of a method according to a preferred embodiment of the invention.

### DETAILED DESCRIPTION OF A PREFERRED EMBODIMENT

As shown in the FIGURE, the invention relates to a method of quickly collecting operational data for internet destinations. While there are more destinations left in a provided input list, the next specification is read, that ping is performed while its performance is timed (described in more detail below), and, the measurements are written to a data log.

The logic of the measurement for a given destination and a set of global defaults is performed by the steps of: parsing the specification into its constituent parts; setting up the transaction request message; creating a TCP/IP socket and setting up input/output access to it; sending a “ping” to the destination; noting the timestamp for that ping transmission; waiting for a reply from the ping; noting the timestamp for that reply when it arrives; and calculating the time taken from transmit to reply. The socket and server connection can then be closed.

There are three nested levels of queues. The first is input, as large as the input file. The input file is provided. The second is Chunk, the number of destinations set by an option, which are drawn from the input file. The third is Flying, the number of pings set by another option, which are drawn from the destinations in the chunk.

A description of parameters useful with this preferred embodiment follows:

mping:help

Usage:mping [opts][ infile]

-hthis help message

-s data-sizein bytes (64)

-p pattern (01)

-n packetspings per host (6)

-d nsimultaneous destinations (3)

-c nchunk size between file I/O (10)

-vverbose: isn't supposed to affect timing

-NDon't fork DNS subprocess

-PPrecompute DNS onto stdout and don't ping

-Ddebug: will damage timing

-S routestrict source route

-L routestrict source route

-Iprint input packet

infileoptional input filename

The present invention may be embodied in other specific forms without departing from the spirit or essential attributes thereof.

What is claimed is:

1. A method of quickly collecting operational data for internet destinations comprising:
parsing a specification into its constituent parts;
setting up a transaction request message;
creating a TCP/IP socket;
setting up input/output access to the TCP/IP socket;
transmitting a ping to a destination;
recording a first timestamp for that ping transmission;
waiting for a reply from the ping;
noting a second timestamp for that reply when the reply arrives; and
calculating the time taken from transmit to reply.
